(19) United States
(12) Patent Application Publication
(10) Pub. No.: US 2026/0045142 A1
(43) Pub. Date: Feb. 12, 2026

(54) SYSTEM AND METHOD TO IMPLEMENT A LOTTERY SECOND CHANCE GAME BASED ON GAME TILES

(71) Applicant: Scientific Games, LLC, Alpharetta, GA (US)

(72) Inventor: Scott B. Garrison, Duluth, GA (US)

(21) Appl. No.: 18/798,957

(22) Filed: Aug. 9, 2024

(51) Int. Cl. G07F 17/32

(52) U.S. Cl. CPC G07F 17/3244; G07F 17/326

(57) ABSTRACT

A system and method for play of a lottery bonus game provides lottery tickets in a primary lottery game that entitle a player to receive a game tile for use in the bonus game, where the game tile is selected from a first set having a first type of graphic symbol thereon or from a second set having a second type of graphic symbol thereon. A randomly generated game board provided to a player has first game tile spaces and second game tile spaces. The player places each of the game tiles they receive in one of the first or second game tile spaces available on the game board to create a string that includes at least one of the second game tiles, the string equating to a result required by the bonus game for an award.

### FIELD OF THE INVENTION

The present invention relates to a second chance or bonus game for ticket-based lottery games, wherein lottery ticket holders in a primary lottery game have the opportunity to win at the second chance game.

### BACKGROUND

Lottery games have become a time honored method of raising revenue for state and federal governments the world over. The success of these games, however, depends on continuous innovations that capture the interests of current players and draw new players to the games.

In one attempt to increase sales, lotteries have adopted second chance games where the consumer can enter codes from losing lottery tickets on lottery internet sites to play instant second chance games (also referred to as “bonus games”) or to enter second chance drawings.

As with other consumers, lottery players are becoming more tech savvy, and are interested in conducting various gaming aspects via electronic devices, such as smart phones. The gaming industry is appreciative of this fact and is seeking ways to integrate games (both primary and second-chance or bonus games) and gaming-related functions into the rapidly developing mobile electronic communication age.

The lottery industry is thus continuously seeking new and creative gaming scenarios that provide increased entertainment value to players, entice new players, and expand play of lottery games (including second chance and bonus games) into the smart electronic communication age.

### SUMMARY OF THE INVENTION

Objects and advantages of the invention will be set forth in part in the following description, or may be obvious from the description, or may be learned through practice of the invention.

In particular embodiments, a system and method are provided for play of a lottery bonus or second-chance game (collectively referred to as a bonus game herein) wherein players redeem a lottery ticket in a primary game and receive a physical (i.e., paper) or digital tile piece (“tile”) for each ticket. The system and method are not limited by the type of primary game. For example, the lottery tickets may be well-known scratch-off tickets. In another embodiment, the lottery tickets in the primary game may be instant-win or draw tickets for a future game (e.g., Pick-3 or Pick-4 games).

In one embodiment, only losing tickets in the primary game are eligible to receive a tile. Alternatively, winning and losing tickets in the primary game are eligible to receive a tile.

In particular, each lottery ticket in the primary lottery game is provided with a code that entitles a player to receive a respective game tile. The use of bar codes, QR codes, or other types of conventional scannable codes on all types of scratch-off lottery tickets, draw-game tickets, or instant-win game tickets is known for various purposes, including security, inventory management, accountability, and validation/redemption. These existing codes may also be used to link the respective ticket to a tile that is predetermined for the ticket or randomly assigned to the ticket when the player redeems the ticket for receipt of the tile. Alternatively, the lottery tickets in the primary game may have a unique code dedicated for play of the bonus game.

The game tile associated with each lottery ticket is selected from a set of first game tiles having a first type of graphic symbol thereon or from a set of second game tiles having a second type of graphic symbol thereon. The tiles may be randomly selected from the set of first game tiles or from the set of second game tiles. There may be more game tiles in the first set of game tiles as compared to the second set of game tiles. Certain tiles in the respective sets may be more common than other tiles, thereby rendering certain of the game tiles harder for the players to acquire.

The method and system supply a unique game board to each player, the game board having a randomly generated array of game spaces that include first game tile spaces for receipt/placement of first game tiles and second game tile spaces for receipt/placement of second game tiles. The game board may be randomly generated each time it is generated or batches of the game boards may be generated.

Upon scanning the code on their lottery ticket, the player is provided with one of the first game tiles or one of the second game tiles.

Instructions are provided to the player to place each of the game tiles they receive in one of the first or second game tile spaces available on the game board to create a string that includes at least one of the second game tiles, wherein the string equates to a result required by the bonus game for an award. The player is presented with the award/prize in the bonus game based on a number of the first and second game tiles used to achieve the result (and a value that may be assigned to different ones of the game tiles).

It is within the scope and spirit of the invention that the bonus game can be played with “hard” game tiles and game boards, such as paper tiles and paper boards that are supplied to the player from a retail location or lottery redemption center where the player is able to present their physical primary game lottery ticket for receipt of a game tile and game board.

It is also envisioned that the bonus game can be played in electronic, digital format wherein the player receives digital tiles and game boards that are stored in a player wallet or account. The player can play the bonus game on a computer or mobile smart device These digital tiles and boards may be transferred to player, for example, upon the player scanning (or having scanned) the code on their primary lottery tickets.

In a particular embodiment, each player has a personalized digital account with a lottery provider, wherein the game board and game tiles stored in the player digital account and electronically retrieved for play of the bonus game on a smart device.

The pattern or configuration of game tile spaces on the game board may vary. For example, the game board may contain a grid of spaces, wherein the first and second game tile spaces are randomly designated in the grid of spaces. The grid may include one or more randomly designated blocked spaces that cannot be used for placement of any of the first or second game tiles. In still further embodiments, the grid of spaces may include one or more randomly designated wild card spaces that be used for play either of the first or second game tiles.

The theme of the bonus game is reflected by the graphic symbols on the game tiles. For example, in one embodiment, the first type of graphic symbol on the first game tiles may be single digit numbers (i.e. “0 ” through “9”) and the second type of graphic symbol on the second game tiles may be mathematical equation symbols (i.e., “+”, “−”, “x”, “/”, and so forth). The game may require that the string of the first game tiles and at least one second game tile equate to a particular number, for example “100.” In other words, the player uses the number digits and equation symbols to mathematically arrive at the value “100”. In other embodiments, the player may seek to mathematically derive the highest value number with the least number of game tiles, or to derive the lowest value number with the greatest number of game tiles. Any use of the game tiles to mathematically derive a number or value called for by the game to win an award or prize is within the scope of the present method and system.

In an embodiment for a different game theme, the first type of graphic symbol on the first game tiles may be consonant letters (e.g., “B”, “C”, “D”, . . . ) and the second type of graphic symbol on the second game tiles may be vowel letters (e.g., “A”, “E”, “I”, “O”, “U”). The game may require that the string of the first game tiles and at least one second game tile equate to a word. The word may be designated/dictated by the game or may be created by the player. In a particular embodiment, the award or prize may be greater for a greater number of the first and second game tiles used to achieve the word.

### BRIEF DESCRIPTION OF THE DRAWINGS

A full and enabling description of the present invention is provided herein, with reference to particular embodiments depicted in the attached drawings and described below.

FIG. 1 is a diagram illustration of a system and method for conducting aspects of the present invention wherein a player acquires digital tiles for play in a second chance or bonus game;

FIG. 2 illustrates non-limiting examples of first and second sets of game tiles used in embodiments of a system and method for play of the second chance game;

FIG. 3 illustrates non-limiting examples of first and second sets of game tiles used in different embodiments of a system and method for play of the second chance game;

FIGS. 4A and 4B are examples of game cards for use in an embodiment of a system and method for play of the second chance game with the game tiles of FIG. 2; and

FIGS. 5A and 5B are examples of game cards for use in an embodiment of a system and method for play of the second chance game with the game tiles of FIG. 3.

### DETAILED DESCRIPTION

Reference will now be made in detail to embodiments of the inventive methods and systems, one or more examples of which are illustrated in the drawings. Each embodiment is presented by way of explanation of the invention, and not as a limitation of the invention. For example, features illustrated or described as part of one embodiment may be used with another embodiment to yield still a further embodiment. It is intended that the present invention include these and other modifications and variations as come within the scope and spirit of the invention.

For sake of example only, the following discussion relates to embodiments of the invention drawn to lottery games, including primary games, bonus games, and second chance games sponsored by state or other jurisdictional lottery authorities. It should be appreciated, however, that the system and method are just as applicable to gaming activities linked to any manner of other gaming authority, such as games conducted within a gaming establishment (e.g., a casino) for patrons of such establishment, or electronic games conducted via an electronic network, such as the internet, for authorized players.

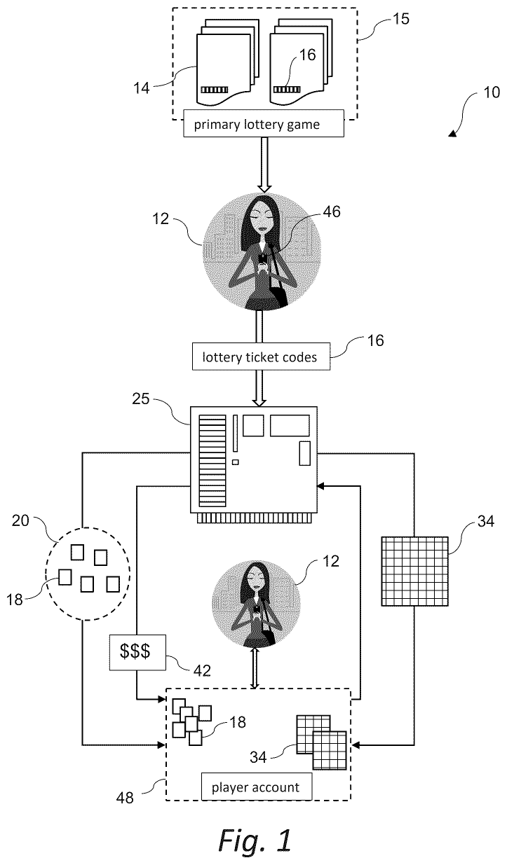

FIG. 1 is a diagram illustration of a system and method 10 in accordance with embodiments of the invention for play of a lottery bonus or second-chance game (“bonus game”) wherein players 12 redeem a lottery ticket 14 in a primary game 15 and receive a physical (i.e., paper) or digital game tile piece 18 (“tile”) for each ticket 14. The system and method 10 are not limited by the type of primary game 15. For example, the lottery tickets 14 may be conventional scratch-off lottery tickets. In another embodiment, the lottery tickets 14 in the primary game may be instant-win or draw tickets for a future game (e.g., Pick-3 or Pick-4 games).

In one embodiment, only losing tickets 14 in the primary game 15 are eligible to receive a tile 18. Alternatively, winning and losing tickets 14 in the primary game 15 are eligible to receive a tile.

Each lottery ticket 14 in the primary lottery game 15 is provided with a code 16 that entitles the player 12 to receive a respective game tile 18. The use of bar codes, QR codes, or other types of conventional scannable codes on all types of scratch-off lottery tickets, draw-game tickets, or instant-win game tickets is known for various purposes, including security, inventory management, accountability, and validation/redemption. These existing codes 16 may also be used to link the respective ticket 14 to a tile 18 when the player 12 redeems the ticket 14 for receipt of the tile 18. Alternatively, the lottery tickets in the primary game may have a unique code 16 thereon dedicated for play of the bonus game.

In a particular embodiment, the game tile 18 that is associated with the lottery ticket 14 is predetermined before the player 12 submits the lottery ticket 14 to a central game server 25 to receive the tile 18. In another embodiment, the central server 25 may randomly select the game tile 18 from a field 20 of different tiles 18 when the lottery ticket 14 is presented by the player 12.

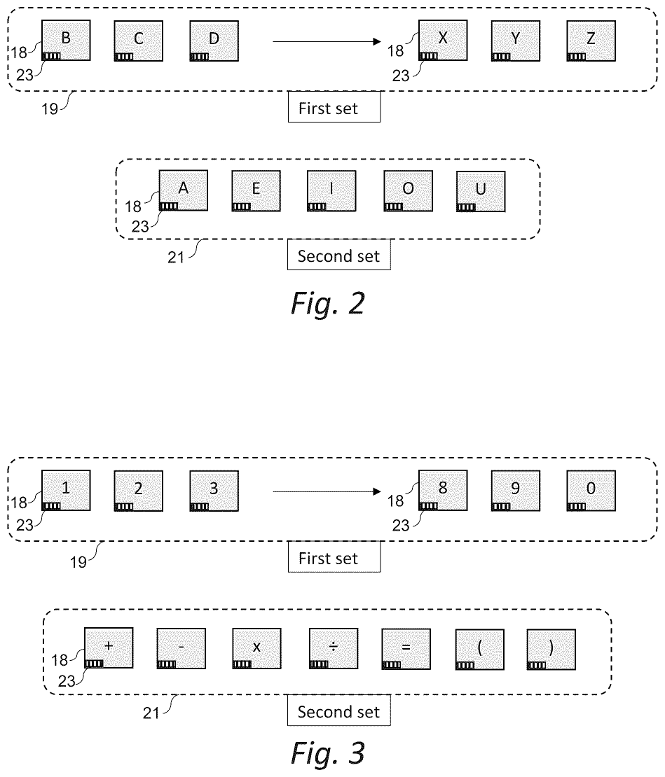

As depicted in FIG. 1, a plurality/field 20 of different ones of the game tiles 18 are generated for play in the bonus game. In particular, referring to FIGS. 2 and 3, each game tile 18 is randomly selected from a set 19 of first game tiles having a first type of graphic symbol thereon or from a set 21 of second game tiles having a second type of graphic symbol thereon. There may be more game tiles 18 in the first set 19 of game tiles as compared to the second set 21 of game tiles. The bonus game may be designed so that generally the player will receive more game tiles 18 from the first set 19 and fewer game tiles 18 from the second set 21. Within each respective set 19, 21, the player may have an equal chance or receiving any one of the game tiles 18 within such set 19, 21. Alternatively, certain tiles 18 within each set 19, 21 may be “rarer” than others, and thus more valuable to the player 12.

As seen in FIGS. 2 and 3, each game tile 18 may include a code 23 thereon, such as a barcode or QR code, which links the game tile 18 to an electronic record stored or accessible by the central server 25, wherein the record includes the graphic symbol on the respective game tile 18. These codes 23 may also be used to verify or assign the game tiles 18 to a player account 48 (described in greater detail below).

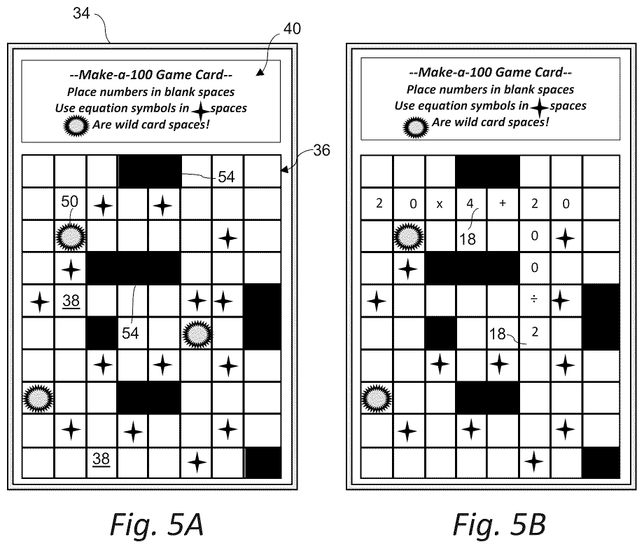

As mentioned, the theme of the bonus game is reflected by the graphic symbols on the game tiles 18. Referring to the embodiment of FIG. 3, the first type of graphic symbol on the game tiles 18 in the first set 19 may be single digit numbers (i.e. “0 ” through “9”) and the second type of graphic symbol on the game tiles 18 in the second set may be mathematical equation symbols (i.e., “+”, “−”, “x”, “/”, and so forth). Referring to the associated game cards in FIGS. 5A and 5B, the second chance/bonus game may call for the string of the game tiles 18 from the first set 19 and at least one game tile 18 from the second set 21 equate to a particular number, for example “100.” In other words, the player uses the number digits (game tiles 18 from first set 19) and equation symbols (game tiles 18 from second set 21) to mathematically arrive at the value “100”. In other embodiments not depicted in the figures, the player may seek to mathematically derive the highest value number with the least number of game tiles, or to derive the lowest value number with the greatest numb er of game tiles. Any use of the game tiles to mathematically derive a number or value called for by the game to win an award or prize is within the scope of the present method and system.

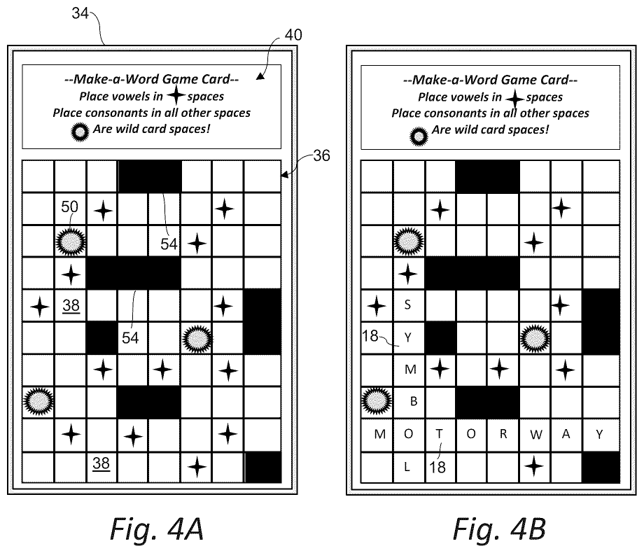

Referring to the embodiment of game tiles 18 and associated game cards 34 in FIGS. 2 and 4A/4B, the first type of graphic symbol on the game tiles 18 from the first set 19 may be consonant letters (e.g., “B”, “C”, “D”, . . .) and the second type of graphic symbol on the game tiles 18 from the second set 21 may be vowel letters (e.g., “A”, “E”, “I”, “O”, “U”). The second chance/bonus game may require that the string of the game tiles 18 from the first set 19 and at least one game tile 18 from the second set 21 equate to a word. The word may be designated/dictated by the game or may be created by the player. In a particular embodiment, the award or prize may be greater for a greater number of the first and second game tiles used to achieve the word.

Referring to FIGS. 4A/4B and 5A/5B, embodiments of the game board 34 have a randomly generated array of game spaces 38 that include spaces designated for receipt/placement of the game tiles 18 from the first set 19 and other game spaces 38 specifically designated for receipt/placement of the game tiles 18 from the second set 21. Each game board 34 may be randomly generated when it is provided to a player or batches of the game boards 34 may be randomly generated and stored by the central server 25 for retrieval and distribution to players.

The pattern or configuration of game tile spaces 38 on the game board 34 may vary. For example, the game board 34 may contain a grid 36 of spaces 38, as indicated in the figures, wherein the first and second game tile spaces are randomly designated throughout the grid 36 of spaces.

The grid 36 may include one or more randomly designated blocked spaces 54 that cannot be used for placement of any of the first or second game tiles 18.

In still further embodiments as depicted in the figures, the grid 36 of spaces 38 may include one or more randomly designated wild card spaces 50 that be used for play either of the first set or second set game tiles 18.

Instructions are provided to the player 12 at one or more places on the game components. For example, the instructions 40 may be printed or displayed on the digital or hard game boards 34, provide via the game website, and so forth. In FIGS. 4A/4B and 5A/5B, the instructions 40 inform the player 12 to place each of the game tiles 18 from the first set 19 in the “free” or open spaces 38 and to place the game tiles 18 from the second set 21 in the specifically designated spaces 38 to form any word allowed by the array/pattern of spaces 38.

As discussed above, the invention contemplates embodiments wherein the bonus game can be played with “hard” game tiles 18 and game boards 34, such as paper tiles 18 and paper boards 34 that are supplied to the player 12 from a retail location, lottery redemption center, or any other authorized location where the player 12 is able to present their physical primary game lottery ticket 14 for receipt of a tile 18 and game board 34.

It the depicted embodiment of the method and system of FIG. 1, the bonus game is played in electronic, digital format wherein upon the player 12 entering the code 16 from a primary game lottery ticket 14 via a website or link maintained by the lottery authority (or authorized third-party) or the player 12 presenting the lottery ticket 14 at a retail establishment for scanning, the central server 25 retrieves a game tile 18 predetermined for the lottery ticket 14 or randomly selects the game tile from the field 20 and transmits the digital game tile 18 to the player's smart device (e.g., mobile phone, tablet, computer, etc.) and also assigns the game tile 18 to the player's electronic account 48. One or more digital game boards 34 is also made available to the player and stored in the player account or wallet 48. At a time of their choosing, the player 12 can access their account, place the saved game tiles 18 in the designated spaces on the digital game board 34, and save the most current arrangement of game tiles 18 on the game board 34. As the player 12 acquires more game tiles 18, the previously placed game tiles 18 can be rearranged on the game board 34 as the player attempts to build and complete the required string.

Once the player 12 completes the string on their digital game card 34, the player submits the completed game card 34 from their account 48 to the central server 25 (e.g., via a provided link or website). Using the stored files associated with the code 23 on the game tiles 18, the server 25 verifies that the string on the game card 34 is valid, wherein an award 42 is then made to the player 12 (e.g., credited to the player's account 42 or otherwise made available to the player). This award 42 may have a monetary value, or could be merchandise, entry into a drawing, and so forth. The award 42 may be based on a number of game tiles 18 used to complete the string. For example, the award 42 may be greater for a greater number of the game tiles 18 used to complete the string. Alternately, the award 42 in the bonus game may be greater for a lesser number of game tiles 18 used to complete the string.

The term “central server” is used herein to encompass any configuration of computer hardware and software that is maintained by a lottery authority or game provider to carry out the functionalities of the present invention, as well as any manner of additional lottery functions. It should be readily appreciated that the server 25 may include an integrated server, or any manner of periphery server or other hardware structure. The game server 25 is typically in communication with a plurality of the retail locations or accessible by smart devices via a suitable secure communication network, which may include any manner of wide area network, wireless internet, or cloud computing.

The game server 25 may be a single networked computer, or a series of interconnected computers having access to the communications network via a gateway or other known networking system. The server 25 may include a memory for storing gaming procedures and routines, a microprocessor (MP) for executing the stored programs, a random access memory (RAM) and an input/output (I/O) bus. These devices may be multiplexed together via a common bus, or may each be directly connected via dedicated communications lines, depending on the needs of the system 10.

The game server 25 may be directly or indirectly connected through the I/O bus to any manner of peripheral devices such as storage devices, wireless adaptors, printers, and the like. In addition, a database (DB) may be communicatively connected to the game server 25 and provide a data repository for the storage and correlation of information gathered from the individual components of the system 10 or may be information relating to individual players, player accounts, games, or game card specific information.

It should be appreciated by those skilled in the art that various modifications and variations may be made present invention without departing from the scope and spirit of the invention. It is intended that the present invention include such modifications and variations as come within the scope of the appended claims.

What is claimed is:

1. A method for play of a lottery bonus game that provides an opportunity for players in a primary lottery game to win an award in the bonus game, the method comprising:
providing lottery tickets in the primary lottery game with a code that entitles a player to receive a game tile for use in play of the bonus game;
wherein the game tile is selected from a set of first game tiles having a first type of graphic symbol thereon or from a set of second game tiles having a second type of graphic symbol thereon;
supplying a unique game board to the player, the game board having a randomly generated array of game spaces that include first game tile spaces and second game tile spaces;
upon the player scanning the code on the lottery ticket, providing the player with the first game tile or the second game tile associated with the lottery ticket;
providing instructions to the player to place each of the game tiles they receive in one of the first or second game tile spaces available on the game board to create a string that includes at least one of the second game tiles and wherein the string equates to a result required by the bonus game for an award; and
awarding the award in the bonus game to the player based on a number of the first and second game tiles used to achieve the result.

2. The method for play of a lottery bonus game according to claim 1, wherein the bonus game is a digital electronic game played by the player on a computer or mobile smart device, the game board and game tiles supplied to the player in digital form.

3. The method for play of a lottery bonus game according to claim 2, wherein the player has a personalized digital account with a lottery provider, the game board and game tiles stored in the player digital account.

4. The method for play of a lottery bonus game according to claim 1, wherein the game board contains a grid of spaces, the first and second game tile spaces randomly designated in the grid of spaces.

5. The method for play of a lottery bonus game according to claim 4, wherein the grid of spaces includes one or more randomly designated blocked spaces that cannot be used for play any of the first or second game tiles.

6. The method for play of a lottery bonus game according to claim 4, wherein the grid of spaces includes one or more randomly designated wild card spaces that be used for play either of the first or second game tiles.

7. The method for play of a lottery bonus game according to claim 1, wherein the first type of graphic symbol on the first game tiles are single digit numbers, and the second type of graphic symbol on the second game tiles are mathematical equation symbols, the result for the string of the first game tiles and at least one second game tile being a numerical value achieved by the string.

8. The method for play of a lottery bonus game according to claim 7, wherein the numerical value is dictated by rules of the bonus game.

9. The method for play of a lottery bonus game according to claim 8, wherein the award is greater for a greater number of the first and second game tiles used to achieve the numerical value.

10. The method for play of a lottery bonus game according to claim 8, wherein the award is greater for a lesser number of the first and second game tiles used to achieve the numerical value.

11. The method for play of a lottery bonus game according to claim 1, wherein the first type of graphic symbol on the first game tiles are consonant letters, and the second type of graphic symbol on the second game tiles are vowel letters, the result for the string of the first game tiles and at least one second game tile being a word achieved by the string.

12. The method for play of a lottery bonus game according to claim 11, wherein the word is dictated by rules of the bonus game.

13. The method for play of a lottery bonus game according to claim 11, wherein the award is greater for a greater number of the first and second game tiles used to achieve the word.

14. A system for play of a lottery bonus game that provides an opportunity for players in a primary lottery game to win an award in the bonus game, the system comprising:
a plurality of lottery tickets in the primary lottery game, each lottery ticket comprising a code that entitles a player to receive a game tile for use in play of the bonus game;
a plurality of first game tiles having a first type of graphic symbol thereon, and a plurality of second game tiles having a second type of graphic symbol thereon;
wherein upon a player scanning the code on the lottery ticket, the player receives one of the first or second game tiles;
a randomly generated game board made available to the player, the game board comprising a randomly generated array of game spaces that include first game tile spaces and second game tile spaces;
written instructions provided to the player to place each of the game tiles they receive in one of the first or second game tile spaces available on the game board to create a string that includes at least one of the second game tiles and wherein the string equates to a result required by the bonus game for an award; and
an award structure, wherein the player receives an award in the bonus game based on a number of the first and second game tiles used to achieve the result.

15. The system according to claim 14, wherein the bonus game is a digital electronic game played by the player on a computer or mobile smart device, the game board and game tiles supplied to the player in digital form.

16. The system according to claim 15, comprising a personalized digital account assigned to the player, the digital game board and digital game tiles stored in the player digital account.

17. The system according to claim 14, wherein the game board contains a grid of spaces, the first and second game tile spaces randomly designated in the grid of spaces.

18. The system according to claim 14, wherein the first type of graphic symbol on the first game tiles are single digit numbers, and the second type of graphic symbol on the second game tiles are mathematical equation symbols, the result for the string of the first game tiles and at least one second game tile being a numerical value achieved by the string.

19. The system according to claim 18, wherein the award is greater for a lesser number of the first and second game tiles used to achieve the numerical value or is greater for a greater number of the first and second game tiles used to achieve the numerical value.

20. The system according to claim 14, wherein the first type of graphic symbol on the first game tiles are consonant letters, and the second type of graphic symbol on the second game tiles are vowel letters, the result for the string of the first game tiles and at least one second game tile being a word achieved by the string.
